(19) United States
(12) Patent Application Publication
(10) Pub. No.: US 2005/0092685 A1
(43) Pub. Date: May 5, 2005

(54) Set comprising a pipette and a cartridge, as well as a method for applying a sample to the cartridge and an analytical method

(75) Inventors: Martinus Josephus Hilhorst, Groningen (NL); Jan Albert Ooms, Emmen (NL)

Correspondence Address: OLIFF & BERRIDGE, PLC, P.O. BOX 19928, ALEXANDRIA, VA, 22320, US

(73) Assignee: SPARK HOLLAND B.V., Emmen (NL)

(21) Appl. No.: 10/930,909

(22) Filed: Sep. 1, 2004

Related U.S. Application Data
(63) Continuation-in-part of application No. 10/345,920, filed on Jan. 17, 2003.

(30) Foreign Application Priority Data
Jan. 17, 2002 (NL) 1019768

(51) Int. Cl. B01D 15/08

(52) U.S. Cl. 210/656; 210/198.2; 436/161; 422/70

(57) ABSTRACT

The invention relates to a set comprising, on the one hand, a pipette having a pipette orifice and, on the other hand, a cartridge. The cartridge comprises: a housing; a chamber, containing sorbent, provided in the housing; an inlet that connects the chamber to the outside of the housing and that has an inlet orifice on the outside of the housing; an outlet that connects the chamber to the outside of the housing; an inlet closure that is permeable to fluid and impermeable to the sorbent, which inlet closure extends over the entire inlet passage; an outlet closure, such as a mesh, that is permeable to fluid and impermeable to the sorbent, which outlet closure extends over the entire outlet passage; wherein the pipette orifice can be accommodated in the inlet orifice. The invention furthermore relates to a method for applying the sample to a sorbent by means of a pipette. In addition to invention relates to an analytical method wherein a sample to be analysed is transferred by means of a pipette to a cartridge and this sample is applied to a sorbent contained in said cartridge and the sample, or at least an analyte present therein, is eluted from the sorbent using an eluent and the sample, or at least the analyte, is then subjected to an analysis, such as HPLC analysis.

The present invention relates to a cartridge comprising:
a housing;
a chamber, containing a sorbent, provided in the housing;
an inlet that connects the chamber to the outside of the housing and that has an inlet orifice on the outside of the housing;
an outlet that connects the chamber to the outside of the housing;
an inlet closure that is permeable to fluid and impermeable to the sorbent, which inlet closure extends over the entire inlet passage;
an outlet closure, such as a mesh, that is permeable to fluid and impermeable to the sorbent, which outlet closure extends over the entire outlet passage.

A cartridge of this type is disclosed in WO 00/54023 in the name of the Applicant; see in particular FIG. 1a thereof. With reference to FIG. 1a of WO 00/54023, this shows a cartridge consisting of a cylindrical housing 11 with a central longitudinal bore in which a sorbent 13 is arranged. The sorbent 13 is held in the bore by means of two mesh closures 12.

In analytical processes where the sample is fed under high pressure to the analytical equipment, as, for example, in the case of liquid chromatography processes where pressures of 200 bar and higher are customary, the problem arises that the sample has to be introduced in some way or other into a process steam that is under high pressure. A basic technique widely used for this is shown diagrammatically in FIG. 4. With this technique, use is made of a so-called 6-way tap 200 (or 6-way valve) with six connections 201, 202, 203, 204, 205 and 206 and three connecting chambers 207, 208 and 209, each of which can connect two of said connections to one another. With this arrangement a distinction is made between a so-called low pressure side to the left of the axis 210 and a high pressure side to the right of the axis 210. On the low pressure side, sample is drawn up from vial 214 by means of a diagrammatically indicated syringe 211 via connection 201, chamber 207 and connection 206 by means of a syringe needle until sample is present in chamber 207. The sample in chamber 207 then has to be brought in a number of ways into the process stream on the right-hand side that is under high pressure, by turning the 6-way tap 200 so that the chamber 207 filled with sample is connected to other connections. One possibility here is to turn the tap 200 such that the chamber 207 moves into he position of chamber 209 (chamber 209 then being in the position of chamber 208 and the chamber 208 then being in the position of chamber 207). The sample can then be introduced into the liquid chromatograph 213 by feeding the sample by means of a liquid column through like 204 to the liquid chromatograph by means of a pump 212 via connection 203 through a chamber 208, via connection 202 and via connection 205 through chamber 209 (which will then be filled with sample). This process can also be carried out via many other switching positions with or without intermediate process steps. The above description is a very brief description which does not pretend to be complete and correct but is merely for illustration. The problem that is clear here is that before a subsequent analysis old sample has to be completely removed from the lines, such as 201, 202, 203, 204, 205 and 206, as well as the chambers 207, 208 and 209 so that old sample will not interfere with a subsequent analysis. A completely different variant of the known principle outlined with reference to FIG. 4 is described in, inter alia, WO 00/54023, which has already been mentioned. Here the sample is introduced into the high pressure process stream by means of a cartridge, containing sample, to be introduced into said high pressure process stream. By means of such a cartridge it is possible, as described in WO 00/54023, to subject the sample to a number of additional process steps prior to the analysis. Thus, the ultimate analysis can be carried out more accurately and more reliably by, for example, as it were washing the sample in such a way that the concentration of the constituent of the sample to be analysed, the so-called analyte, is increased or, at least, impurities are removed from the sample.

As is described in WO 00/54023, a sample containing analyte is applied to the sorbent by feeding a liquid containing the sample through the bore containing the sorbent. The sample is then retained on the sorbent. A wash liquid can the be fed through the cartridge to wash the sorbent. In order to be able to subject the analyte to the analytical process, this is then eluted from the sorbent by means of an eluent fed through the cartridge. With this procedure, in particular the way in which the sample is applied to the sorbent with the aid of inter alia, a so-called auto-sampler is laborious. The sample is typically supplied in a vial, drawn up from this vial, then fed through the cartridge under pressure, during which operation sample, or at least analyte contained therein that is to be analysed, is applied to the sorbent. Thus, the sample is fed through various lines before it passes from the vial onto the sorbent. A number of disadvantages are associated with this multi-step process. When successively applying various samples to the sorbent in various cartridges it can be the case that there is still sample from a previous application left in the lines. In order to counteract this as far as possible, the lines must be flushed. Furthermore, the suction orifice, usually a needle, by means of which the sample is drawn up from the vial, always has to be cleaned in the interim or replaced in the interim in order to prevent contamination of sample in the one vial by sample from the other vial.

Furthermore, a relatively large amount of sample is needed with this process. If small quantities of sample are available, it can prove difficult to apply sufficient sample to the sorbent in practice.

The aim of the present invention is to overcome the abovementioned problems by making simplified application of sample to the sorbent possible.

The abovementioned aim is achieved according to the invention by providing a set comprising, on the one hand, a pipette having a pipette orifice and, on the other hand, a cartridge, wherein the cartridge comprises:
a housing,
a chamber, containing a sorbent, provided in the housing;
an inlet that connects the chamber to the outside of the housing and that has an inlet orifice on the outside of the housing;
an outlet that connects the chamber to the outside of the housing;
an inlet closure that is permeable to fluid and impermeable to the sorbent, which inlet closure extends over the entire inlet passage;
an outlet closure, as a mesh, that is permeable to fluid and impermeable to the sorbent, which outlet closure extends over the entire outlet passage; wherein the pipette orifice can be accommodated in the inlet orifice.

With this arrangement the pipette can be either a manual pipette or a pipette forming part of a pipetting robot. With this arrangement the pipette contains a measured amount of sample that is fed directly from the pipette to the cartridge, in particular is applied onto the sorbent contained therein. In order to ensure that the sample contained in the pipette passes quantitatively into the sorbent containing chamber of the cartridge, it is important which this arrangement that the pipette orifice can be accommodated in the inlet orifice. Applying sample to the sorbent in this way prevents retention of sample in line systems, and it is furthermore possible to ensure that all the sample passes onto the sorbent, even in the case of very small amounts of sample, for example samples of less than 15 μl. This is because the complete sample can be injected into the cartridge. The more sample passes onto the sorbent the more sensitive will be the final analysis. A further advantage is that using a set of this type it is possible even to apply the sample to the sorbent in the field. Thus, this no longer has to take place in special sampling or analytical equipment. Here, in the field is understood to be not only in the open air but also in a laboratory or some other place where the sample is taken. The sample can then be transferred immediately to the sorbent after it has been taken using the pipette. The invention thus provides a very simple injection principle for applying sample to the sorbent.

So as to minimise, if not to be able completely to prevent, spillage of sample when transferring to the sorbent, according to the invention it is advantageous if the pipette end containing the pipette orifice and the inlet orifice are so constructed that when the pipette orifice is accommodated in the inlet orifice the pipette end and the wall section of the housing surrounding the inlet orifice, viewed in the circumferential direction of the pipette point, can make sealing contact. What is achieved in this way is that the pipette orifice connects onto the inlet orifice.

For the purposes of simple and reliable orientation of the pipette orifice in the inlet orifice, according to the invention it is advantageous if the pipette point and the inlet orifice are both of tapered, such as conical, construction. In order to be able to achieve a good seal with this arrangement in a simple and reliable manner, according to the invention it is advantageous if the degree of taper of the inlet orifice has a more obtuse angle than the degree of taper of the pipette point. Specifically, in this way it is possible to achieve a linear seal in the circumferential direction of the pipette point with adequate contact pressure of the pipette point. Preferably the inlet orifice will be conical with an angle of conicity in the range from 30° to 35°. In particular the angle of conicity will be approximately 32°. With this angle of conicity the cartridge is well suited for use with a wide range of pipettes known per se in practice.

In order to improve the transfer of sample from the pipette to the sorbent, according to the invention the inlet closure may comprises filter paper, in particular is made of filter paper. With this arrangement this filter paper acts as an intermediary between the pipette and the sorbent. The filter paper as it were sucks the sample from the pipette in order subsequently to transfer this sample to the sorbent. Inter alia, the last residues of sample that will possibly remain on the bottom of the pipette point will thus be sucked off the pipette point by the filter paper, which counteracts spillage of the sample and contamination by the sample.

According to an advantageous embodiment of the invention, the sorbent comprises grains having a grain size of less than 140 μm, in particular less than 75 μm, such as grains having a size of approximately 50 μm. What is achieved with such a small grain size is that capillary action takes place in the space between the grains. In this way application of the sample to the entire sorbent is ensured in a simple manner, without substantial pressure having to be delivered through the pipette for this purpose. The sample is automatically drawn into the sorbent as a result of the capillary action. With this arrangement the grains are preferably made of an essentially inert material, such as glass beads. This makes the subsequent separation, which is also referred to as elution, of the sample from the sorbent very easy. All that is required is to pass an eluent through the sorbent under pressure.

The cartridge will usually have a cylindrical shape with a diameter of less than 12 mm even less than 9 mm, for example approximately 8 mm.

According to a further aspect, the present invention relates to a method for applying a sample to the sorbent in a cartridge, wherein the sample is fed to the cartridge by means of a pipette.

According to yet a further aspect, the invention relates to an analytical method wherein a sample to be analysed is transferred to a cartridge by means of a pipette and this sample is applied to a sorbent contained in the cartridge and the sample, or at least an analyte contained therein is eluted from the sorbent using an eluent and the sample, or at least the analyte, is then subjected to an analysis.

The set according to the invention, as well as the method of application according to the invention and the analytical method according to the invention, are well suited, inter alia, for use with a so-called “solid phase extraction instrument”, as disclosed, for example, in WO 00/54023 in the name of the Applicant, which has already been mentioned above. Solid phase extraction (abbreviated as SPE) in general comprises one or more of the following steps.
(a) conditioning of a sorbent in a cartridge, a liquid suitable for conditioning being passed through the cartridge;
(b) application of a sample that contains the analyte to the sorbent, a liquid that contains the sample being passed through the cartridge;
(c) washing the sorbent, a wash liquid being passed through the cartridge;
(d) elution of the analyte from the sorbent, an eluent being passed through the cartridge.

If the set according to the invention is used, steps (a) and (c) of these are optional; with the set according to the invention these two steps will even frequently be superfluous. Step (a) serves to moisten the surface of the sorbent to create a phase that can absorb the analyte easily. In step (b) the substance to be analysed, the analyte, is applied to the sorbent. In step (c) the sorbent is washed so that constituents that could interfere with the detection of the analyte are removed. In step (d) the analyte is eluted from the sorbent so that, in a subsequent step, it can be detected, for example by gas chromatographic analysis (GC) or by means of liquid chromatography (HPLC).

As will be clear, the present invention therefore also relates to the use of the set according to the invention in a solid phase extraction process.

The present invention also relates to a method for introducing an analyte into a liquid chromatograph, wherein a set according to the invention is used to transfer the analyte from the pipette onto the sorbent contained in the cartridge and wherein the cartridge is then accommodated in a line system through which a liquid stream is fed under high pressure to a liquid chromatograph. In this way the analyte is entrained out of the sorbent by the liquid under high pressure, in order to be analysed in the liquid chromatograph.

The present invention will be explained in more detail below with-reference to an example shown in the drawing. This example serves merely for illustration of the invention and is certainly not intended to restrict the invention. In the drawing;

### LEGENDS TO THE FIGURES

FIG. 1a shows a plan view of a cartridge according to the invention for use with a set according to the invention;

FIG. 1b shows, diagrammatically, a set according to the invention with the cartridge in longitudinal section according to 1b in FIG. 1a and a view of the pipette;

FIG. 2 shows, diagrammatically, the use of the cartridge according to the invention in an SPE instrument.

FIG. 3 shows, diagrammatically, a perspective view of an SPE instrument, which view corresponds to FIG. 1 in WO 00/54023; and

FIG. 4 shows, diagrammatically, a system from the prior art.

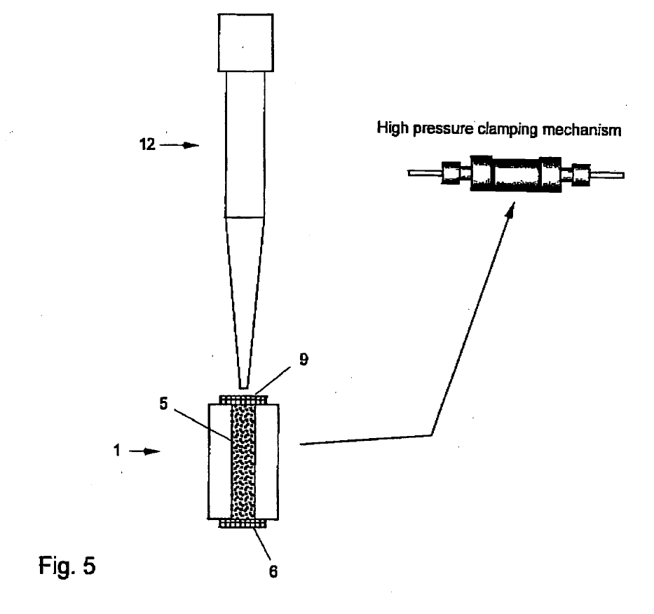

FIG. 5 shows in a longitudinal section a cartridge (1) according to the invention comprising a particulate sorbent material (5) kept in place by an inlet closure (9) and an outlet closure (6), e.g. made of stainless steel. By way of example, a pipette (12) is shown as well which may be used to apply a sample through the closure onto the sorbent material FIG. 6 shows in a longitudinal section a cartridge (1) according to the invention comprising a monolithic sorbent (5). The cartridge may be provided with an inlet orifice (10). By way of example, a pipette (12) is shown to illustrate application of a sample onto the sorbent. However, other ways of sample application may also suitably be used such as a sampling capillary or fraction collection.

FIG. 7 schematically illustrates how a predetermined sample volume can be applied to a cartridge-contained sorbent material using a capillary (15). The sorbent material can be in the form of a bed of sorbent particles (A) or in the form of a porous rod (B).

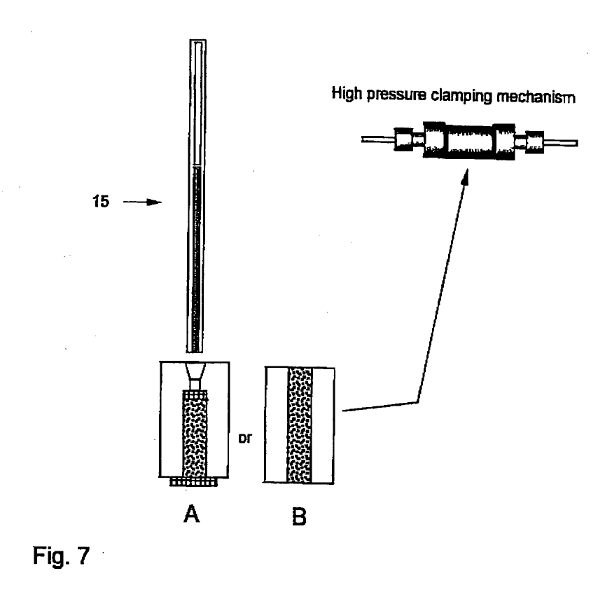

FIG. 8 schematically illustrates the application of a sample onto a sorbent (A; particulate) (B; monolithic) using an automated sampling system capable of taking a sample and pumping the sample to the cartridge where it is collected onto the sorbent.

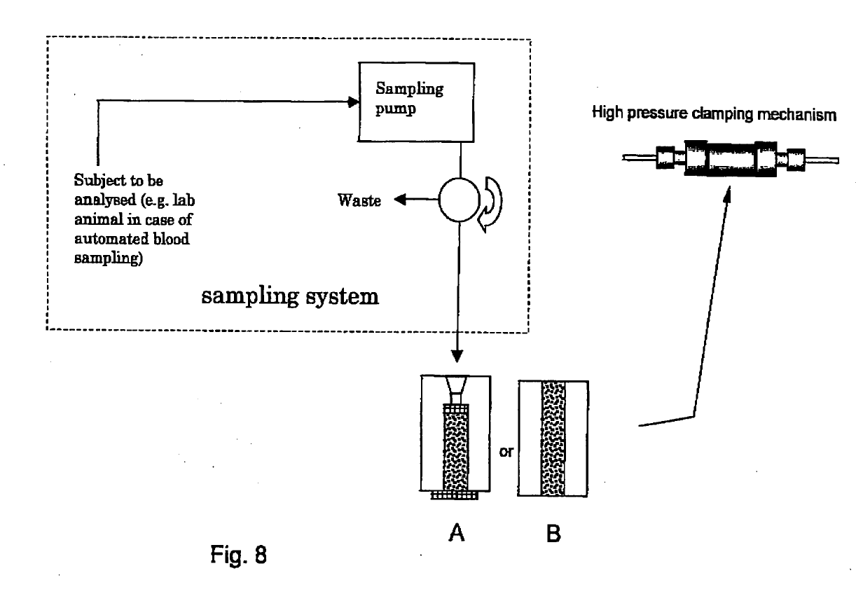

FIG. 9 schematically illustrates the application of a sample onto a sorbent-containing cartridge by fraction collection, in this case HPLC fraction collection. First, a sample is subjected to HPLC analysis after which one or more individual fractions eluting from the HPLC system are collected (either manually or automatically) onto one or more cartridges containing a sorbent (A; particulate) (B; monolithic). Once loaded with sample, the cartridges(s) can be used to introduce the sample(s) in an analytical system. The eluting fractions may pass through a detector prior to be collected onto a cartridge. An automated fraction collector may be connected to the detector to aid in collection of certain fractions of interest, for example those containing a certain amount of analyte(s) of interest, such as proteins or another detectable analyte.

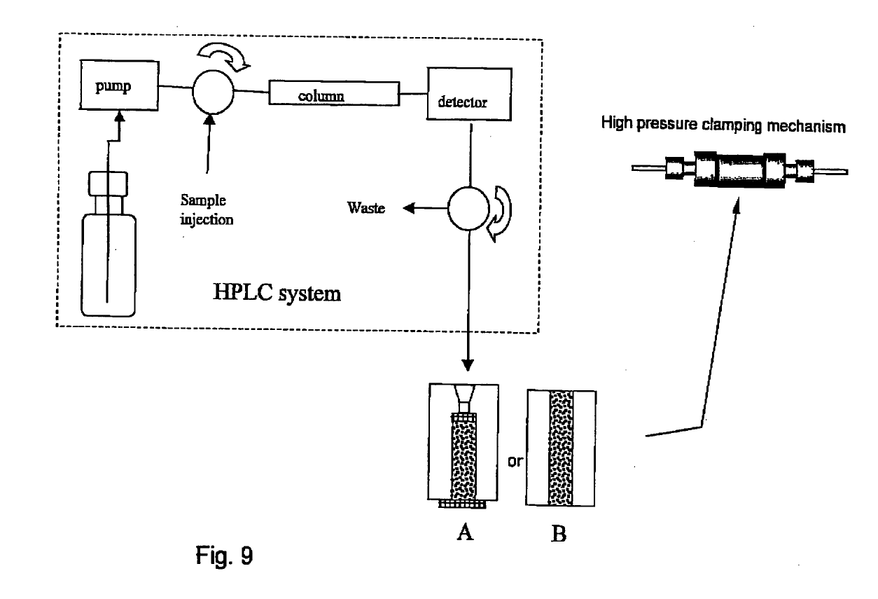

FIG. 10 shows the so-called “micro sorbent sampling” concept. A cartridge (1) with a small internal diameter containing a sorbent (5; either particulate or monolithic) is provided with an inlet orifice (10) as well as an outlet orifice (16) to aid in the alignment of the connecting tubing ends to the sorbent when clamping the sorbent cartridge in the flow path of an analytical system. By way of example, a pipette 12 is shown to illustrate application of a sample onto the sorbent. However, other ways of sample application may also suitably be used.

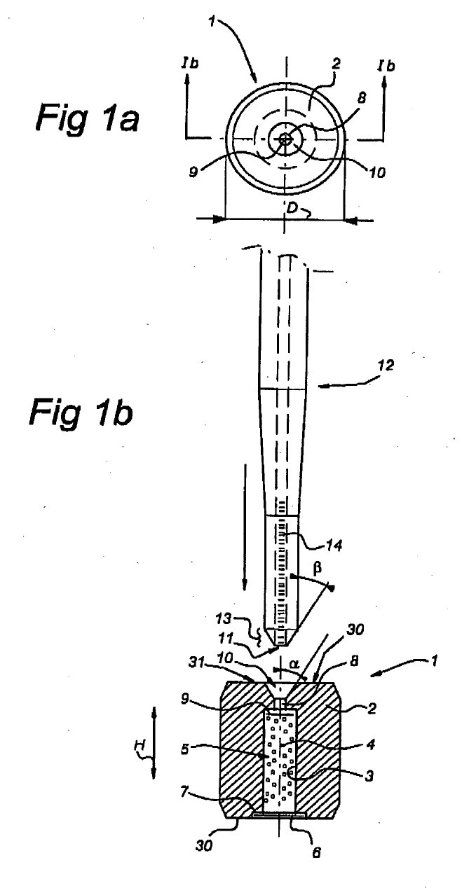

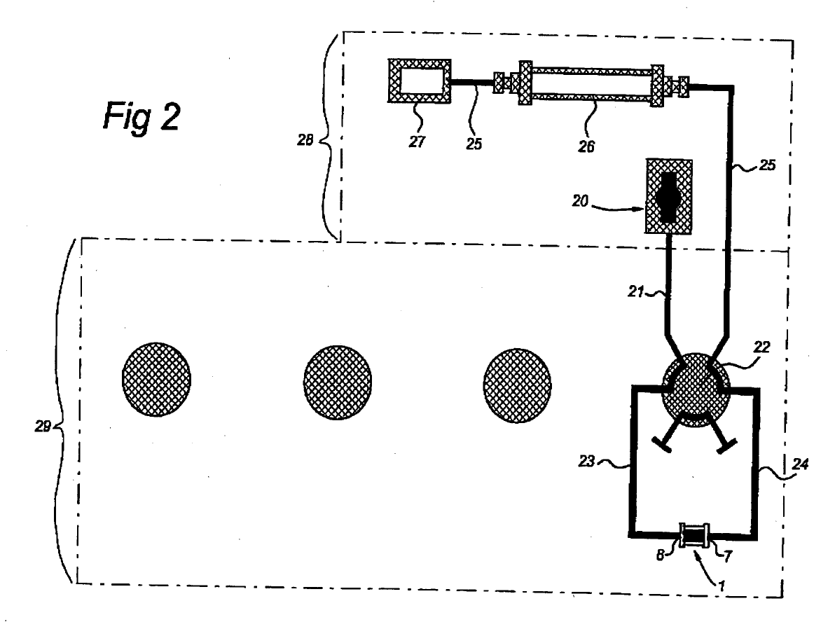

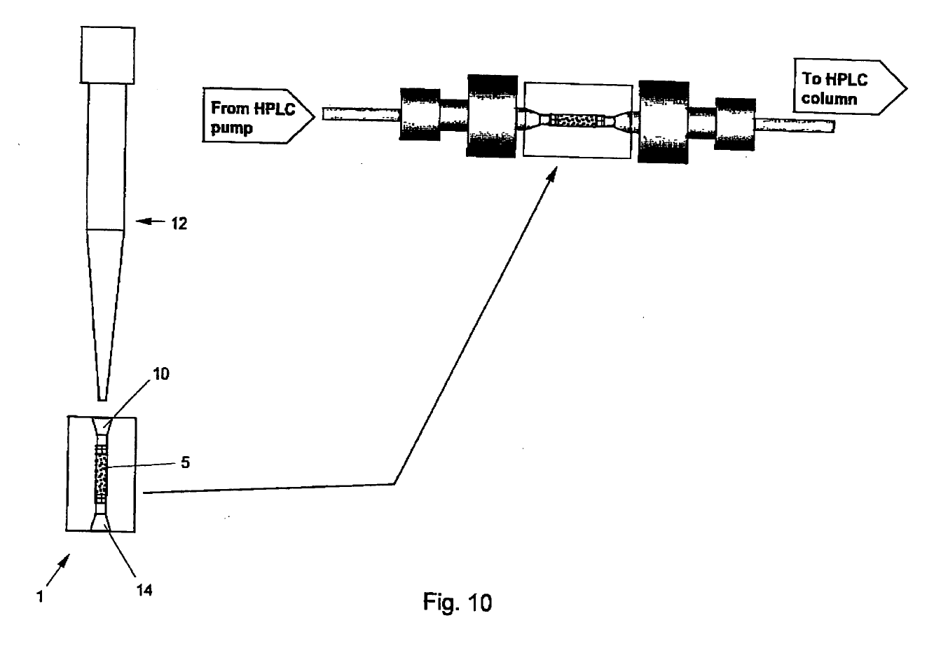

With reference to FIGS. 1a and 1b, a cartridge is indicated by 1. Such a cartridge usually has dimensions in the range from 10 to 20 mm in the height direction H and a diameter of approximately 8 mm in the width direction D. These values for the dimensions of the cartridge 1 are intended solely by way of indication, as are also dimensions of the cartridge 1 to be mentioned further below.

As is shown in FIGS. 1a and 1b, the cartridge 1 is cylindrical. The cartridge 1 can optionally also have a different shape, such as a block shape. As has been stated, the cartridge 1 consists of a cylindrical housing 2 with a bore 3 therein. In this example, the bore 3 has a diameter of approximately 2 mm and defines a chamber in which sorbent 5 is accommodated. In this illustrative embodiment the sorbent 5 consists of spheres 4, in particular so-called glass beads having a grain size of approximately 50 μm. In order to keep the sorbent in the chamber 3 the latter is closed at the outlet 7 by means of a mesh 6. This mesh 6 is recessed in the housing 2. An inlet 8 is provided at the other longitudinal end of the chamber 3. This inlet 8 has an inlet orifice 10 opening on the outside 30 of the housing 2. The inlet orifice 10 is of conical construction with an angle of conicity a. In order to prevent the sorbent 5 leaving the housing 2 via the inlet 8, the chamber 3 is provided with an inlet closure 9. This inlet closure 9 can also be a mesh but is, in particular, a piece of filter paper.

FIG. 1b furthermore shows a diagrammatic view of a pipette 12. The pipette 12 has a pipette orifice 11 at its inlet/outlet end, called pipette point 13. The pipette point 13 has an end section of conical construction. This end section of conical construction has an angle of conicity B. As indicated diagrammatically, the pipette 12 contains a sample 14.

In order to apply the sample 14 from the pipette 12 onto the sorbent 5 the pipette orifice 11 is inserted into the inlet orifice 10 and the pipette 12 is operated to dispense sample via the pipette orifice. So that a reliable linear seal can be achieved all round the pipette orifice 11 between, on the one hand, the pipette point 13 and, on the other hand the housing 2 it is preferable according to the invention if the angle of conicity ct is greater than the angle of conicity B.

As a consequence of the size of the grains 4, capillary action takes place, as a result of which the sample 14 dispensed onto the sorbent 5 automatically penetrates deep into the sorbent 5. As a consequence of the capillary action it is not necessary to inject the sample, 14 into the chamber 3 under force. With this arrangement the filter paper 9 also has the additional effect that this also has a capillary action which produces distribution of the sample over the cross-sectional surface of the chamber 3 directly at the inlet, as a result of which the sample can be drawn into the sorbent more effectively by the capillary action.

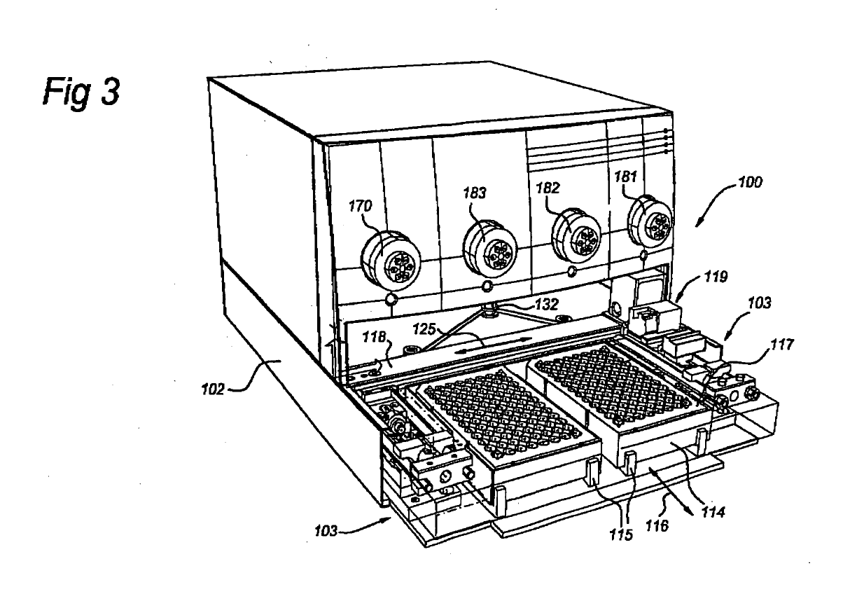

When the cartridge 1, or at least the sorbent 5 therein, has been loaded with sample this cartridge can be placed, for example, in an SPE instrument 29 for analysis in an analytical device 28; see FIG. 2. Further referring to FIG. 2, it can be seen that the analytical device 28 contains a pump 20 that is connected to a line 21, which, via a multi-way valve 22, is in communication with a line 23 that emerges at the inlet 8 of the cartridge 1. The line 24 connects onto the outlet 7 of the cartridge 1, which line 24 is in communication, via the same multi-way valve 22 and line 25, with in this example, a liquid chromatography column 26 and a detector 27. A pressurised effluent is passed through the cartridge 1 under pressure via pump 20. The pump pressure depends on the counter-pressure in the analytical device and can range from 1 bar or even less to more than 10 bar, for example 200 bar. This effluent, which can be either a gas or a liquid, but is usually a liquid, entrains the sample, or at least the analyte, absorbed in the sorbent in order to feed this to the analysis.

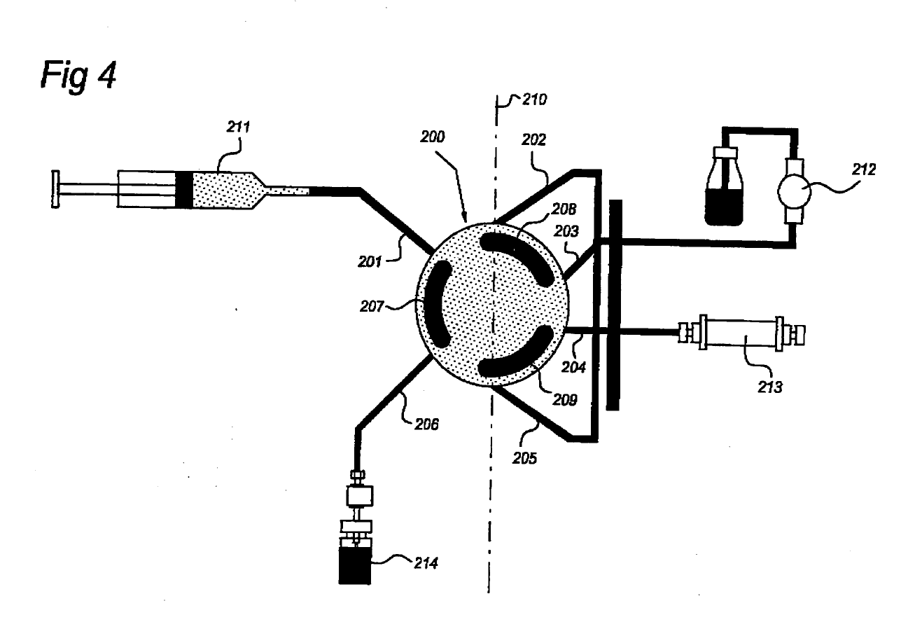

FIG. 3 shows, by way of illustration, a diagrammatic, but more detailed view of an SPE instrument 100 as disclosed in WO 00/54023. FIG. 3 corresponds to FIG. 1 in said WO 00/54023, with the understanding that all reference numerals have been increased by 100 compared with FIG. 1 in WO 00/54023. For the description of FIG. 3 reference is made to the description of the figure in WO 00/54023, which in this context must be considered as being incorporated into the present application.

With regard to the SPE instrument according to WO 00/54023, it is pointed out for the sake of completeness that the (auto) sampling section thereof (that is of assistance when loading the cartridge with sample) is essentially superfluous when using the present invention. This does not stop the present invention being very suitable for use with the instrument from WO 00/54023, optionally by providing this instrument with an additional or replacement sampler working with a pipette.

As will be clear, the set according to the invention is much more than merely an improvement to be used with the instrument as disclosed in WO 00/54023. The set according to the invention can also be used completely independently of the instrument described in WO 00/54023, optionally with other processes or instruments.

Because it is possible to work with a pipette with disposable pipette ends 12, it is possible to make rinsing/cleaning of the line in the sampler unit completely superfluous. After all, the pipette end takes up the sample in order to dispense this to the cartridge, after which the pipette end is thrown away. With this arrangement no parts other than the pipette end and the cartridge come into contact with sample.

As is illustrated in the EXAMPLES and FIGURES, many variants of the present invention are conceivable. According to a method of the invention, the sorbent material, the way in which the sample is applied on the sorbent cartridge, and the design of the sorbent cartridge can vary in a number of ways.

According to the invention, various types of cartridges are provided. Typically, a cartridge according to the invention contains a sorbent material that readily absorbs a sample, preferably without any external force. For instance, apart from grains 4 such as glass beads, the sorbent 5 can comprise many sorbent materials/compositions already known from the state of the art. Hydrophilic particles (silica, glass, etc) have shown to be useful for aqueous samples, whereas hydrophobic particles will be typically be used for samples contained in organic solvents. The sorbent can, for example, be so chosen depending on the analyte to be analysed that it has a specific affinity for retaining said analyte, in particular or absorption of said analyte. In this way it then, for example, becomes possible to use the abovementioned step (c), which is not with regard to SPE processes, in which the sorbent is washed with a wash liquid in such a way that components of the sample which are not part of the analyte are flushed out. This can increase the accuracy of the analysis or have a beneficial influence in some other way on the results to be achieved by the analysis.

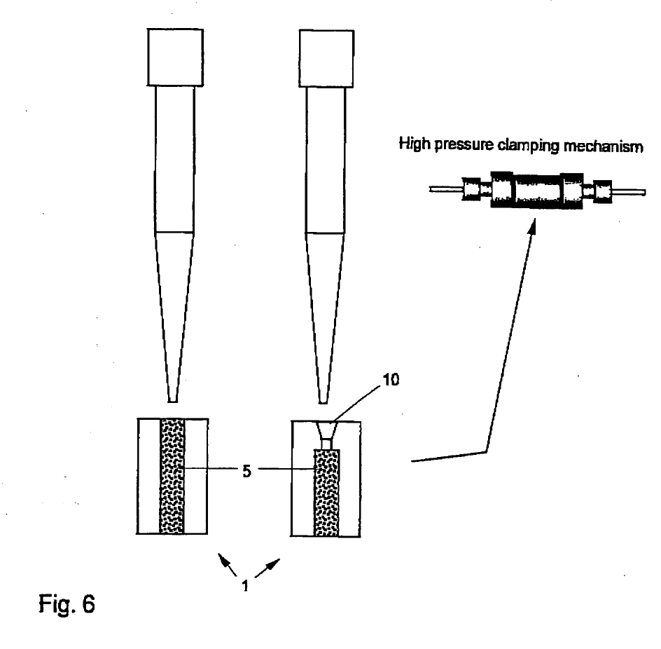

As described above, a sorbent cartridge may contain a sorbent material in the form of a bed of particles capable of absorbing the sample. The particles need to be kept in place, preferably by two closures, sieves, screens, meshes or frits at both ends of the sorbent bed as a closing means. The meshes can be made of various materials, such as filter paper or metal. In one embodiment, the invention provides a cartridge (1) comprising a housing (2); a chamber (3), containing a sorbent (5), provided in the housing; an inlet (8) that connects the chamber (3) to the outside of the housing (2); an outlet (7) that connects the chamber (3) to the outside (30) of the housing (2); an inlet closure (9) that is permeable to fluid and impermeable to the sorbent (5), which inlet closure (9) extends over the entire inlet (8) passage; an outlet closure (6) that is permeable to fluid and impermeable to the sorbent, which outlet closure (6) extends over the entire outlet (7) passage; wherein said inlet and said outlet closure are a mesh made of stainless steel. Such a cartridge is shown in FIG. 5. A cartridge with a stainless steel closure is preferably used for non-aqueous samples, because the steel will to some extent repel aqueous solvents.

In another embodiment of the present invention, a so called monolithic sorbent is used. A monolithic sorbent is a porous rod and is not particulate. Accordingly, in case a monolithic sorbent is used as sorbent material in a cartridge of the invention, no closing means are required to retain the sorbent particles in the cartridge. Such a monolith may consist of a single porous piece of material, but it may also consist of a moulded or compressed mixture of different types of (fibrous) materials. Thus, also provided herein is a cartridge (1) comprising a housing (2); a chamber (3), containing a sorbent (5), provided in the housing; an inlet (8) that connects the chamber (3) to the outside of the housing (2); an outlet (7) that connects the chamber (3) to the outside (30) of the housing (2); wherein said sorbent (5) is a porous rod. Of particular interest is the so-called “fiber monolith” material that is used in ink-cartridges commonly used in PC-printers. A cartridge according to the invention comprising a monolithic sorbent rod may be provided with a conical inlet and/or outlet.

The geometry of the sorbent cartridge should match the format of the LC separation: a small LC separation column requires a small sorbent cartridge to avoid adverse effects on the LC efficiency. Therefore, sorbent sampling cartridges should be available in the range of sub-microliter bed-volumes for capillary-LC (internal column diameter<1 mm), 1-5 microliter for micro-LC (internal column diameter 1-2 mm) and 5-50 microliter for conventional LC (internal column diameter 2-5 mm). Reducing the internal diameter of the sorbent sampling cartridge is the most obvious and most practical way to reduce sorbent bed volume. In case the internal diameter of the cartridge becomes too small for the pipette tip for reliable sample application, a (conical) inlet orifice of the sorbent cartridge may be required to guide the pipette tip to the sorbent. In addition, a sorbent cartridge provided with an inlet orifice as well as an outlet orifice is advantageous to help alignment of the connecting tubing ends to the sorbent, when clamping the sorbent cartridge in the high pressure flow path of an analytical system, such as a HPLC system. Thus, if the diameter of the sorbent bed (either particulate or monolithic) is small, a cartridge according to the invention is preferably provided with a (conical) inlet orifice as well as a (conical) outlet orifice, because these allow for a tight fit when the cartridge is accommodated in a line system through which a liquid stream is fed under high pressure to a liquid chromatograph.

In addition to variations in the type of sorbent material (either particulate or monolithic) and the design of the cartridge (with out without closures and with or without orifice(s)), also the manner how a sample can be transferred to the cartridge-contained sorbent material can vary.

In one embodiment, a method for applying a sample to a sorbent in a cartridge comprises adding a sample to the cartridge by means of a pipette. A sample can be applied on the sorbent cartridge using conventional pipetting instruments for manual pipetting of accurately pre-defined sample volumes or by automated pipetting devices (pipetting robots or liquid handling robots), for example using a set of a pipette and a cartridge with a conical inlet orifice as described above. In another embodiment, the cartridge is not provided with an inlet orifice and the pipette is simply contacted with the inlet closure (e.g. a mesh of stainless steel) and emptied such that the sample can be absorbed by the sorbent material. In yet another embodiment, the pipette is contacted with the surface of a monolithic sorbent rod.

In another aspect, the invention provides a method for applying a sample to a sorbent in a cartridge, wherein the sample is supplied to the sorbent contained in a cartridge by means of capillary action. Capillary action is a physical effect caused by the interactions of a liquid with the walls of a thin tube, e.g. a thin glass capillary. The capillary effect is a function of the ability of the liquid to wet a particular material. For blood sampling, the traditional blood sampling capillaries (as used for finger-puncture sampling) may be used to apply blood samples onto a sorbent (be it a bed of sorbent particles or a monolithic sorbent) material contained in a cartridge. By simply contacting the filled capillary with the sorbent material, the sample will be drawn out of the capillary into the sorbent. Optionally, a pressure can be applied for a complete transfer of the sample from the capillary into the sorbent material. Optionally, the capillary may be guided to the sorbent material by a (conical) inlet orifice. Once the blood sample is applied onto the sorbent, the cartridge can be accommodated in the liquid flow of an analytical instrument, e.g. a HPLC system.

Yet another way of applying a sample on a sorbent cartridge of the invention comprises the (automated) collection of a sample onto the sorbent. An automated sampling device may collect samples in an automated fashion on sorbent cartridges which can then be transferred to the HPLC system, in a similar fashion as the pipetting robot. In one preferred embodiment, an automated blood sampling device (as used for sampling blood from freely moving laboratory animals) is used to apply a blood sample to a sorbent material contained in a cartridge of the invention. In another preferred embodiment, fraction collection comprises collecting at least one fraction eluting from liquid chromatography (LC) column. For example, fractions of (HP) LC effluent are collected on sorbent cartridges for subsequent introduction in a second (HP) LC system for further analysis. This is of particular interest for a multidimensional LC separations analysis which is frequently used in for instance proteomics analysis.

Advantages of the present invention as compared to the common autosampler injection are:

1. sample loss is virtually reduced to zero: the entire volume of sample aspirated by the pipette or capillary is dispensed onto the cartridge. There is no transfer of sample through connecting tubing (needle-valve) thus eliminating their inherent cause of sample loss. Moreover, since the intermediate autosampler vial is also eliminated, there is no loss caused by sample-out-of-reach of the autosampler needle.

2. Carry-over sources eliminated: the use of disposable pipette tips (as is usual for pipetting of samples) or disposable capillaries eliminates the sampling probe (autosampler needle) as a carry-over source. Also, sample is not transferred through connecting tubing between sampling probe and injection valve, eliminating another source of carry-over. Only the connection between the sorbent cartridge outlet and the high pressure switching valve will contact the sample. However, this will only happen when the mobile phase of the HPLC system transfers the sample from the cartridge towards the HPLC column and since the mobile phase is inherently a proper solvent for the sample (no chromatography could otherwise take place), the risk of adsorption of sample on system components is highly reduced.

3. Less sample transfer steps: since the use of a pipette/capillary/fraction collecetion combines both sample transfer from sample storage container and the measuring of a known aliquot of sample for injection, the usual sample measuring action by the autosampler syringe is now omitted. This also omits the need to transfer the sample to the autosampler vial for sampling. This is a significant reduction of sample manipulations, increasing both precision and robustness. Robustness is further increased because there is no autosampler tubing or needle that can be damaged or blocked.

4. Speed of injection and sample throughput are significantly increased: the use of disposable pipette tips (as is usual for pipetting of samples) and disposable sorbent cartridges obviates the need for cleaning prior to the next sample transfer. Moreover, since the action of loading the cartridge with sample is performed off-line from the LC process, it will not have any contribution to the LC run time. Loading the cartridges with sample can take place in parallel with the LC-process as a further improvement of sample throughput.

1. A cartridge (1) for use in a HPLC-system, comprising a housing (2); a chamber (3), containing a sorbent material (5), provided in the housing; an inlet (8) that connects the chamber (3) to the outside of the housing (2); and an outlet (7) that connects the chamber (3) to the outside (30) of the housing (2).

2. Cartridge according to claim 1, further comprising an inlet closure (9) that is permeable to fluid and impermeable to the sorbent (5), which inlet closure (9) extends over the entire inlet (8) passage; an outlet closure (6) that is permeable to fluid and impermeable to the sorbent, which outlet closure (6) extends over the entire outlet (7) passage.

3. Cartridge according to claim 2, wherein the inlet closure (9) is sunken with respect to the outside (30) of the of the cartridge (1).

4. Cartridge according to claim 2, wherein said inlet and said outlet closure comprises filter paper or a mesh made of stainless steel.

5. Cartridge according to claim 1, wherein said sorbent material (5) is a porous rod or a fibrous material.

6. Cartridge according to claim 1, wherein the inlet (8) has in inlet orifice (10) on the outside (30) of the housing (2).

7. Cartridge according to claim 5, wherein the inlet orifice (10) is conical with an angle of conicity in the range from 30° to 35°, in particular approximately 32°.

8. Cartridge according to claim 5, wherein the outlet (7) has an outlet orifice (16) on the outside (30) of the housing (2).

9. Cartridge according to claim 1, wherein the cartridge (1) has a diameter of less than 12 mm, such as less than 9 mm, for example approximately 8 mm.

10. Cartridge according to claim 1, wherein the sorbent material (5) comprises grains (4) having a grain size of less than 140 μm, in particular less than 75 μm, such as grains having a grain size of approximately 50 μm.

11. Cartridge according to claim 9, wherein the grains (4) are made of an essentially inert material, such as glass beads.

12. A set comprising a cartridge according to claim 1 and a pipette or a capillary.

13. Set according to claim 12, wherein said capillary is a blood sampling capillary.

14. Set according to claim 12, wherein the cartridge is a cartridge according to claim 5 and wherein the pipette (12) has a pipette orifice (11) which can be accommodated in the inlet orifice (10) of the cartridge.

15. Set according to claim 14, wherein a pipette end (13) containing the pipette orifice (11) and the inlet orifice (10) arm so constructed that when the pipette orifice (11) is accommodated in the inlet orifice (10) the pipette end (13) and the wall section (31) of the housing (2) surrounding the inlet orifice (10) can make sealing contact with one another in the circumferential direction of the pipette point (13).

16. Set according claim 15, wherein the pipette point (13) and the inlet orifice (10) are both of tapered, such as conical, construction.

17. Set according to claim 16, wherein the degree of taper of the inlet orifice (10) has a more obtuse angle than the degree of taper of the pipette (12).

18. Method for applying a sample to a sorbent in a cartridge for subsequent HPLC analysis, wherein the sample is applied to a sorbent cartridge according to claim 1 by means of a pipette, a capillary or by fraction collection.

19. Method according to claim 18, wherein said fraction collection comprises collecting at least one fraction eluting from a liquid chromatography column.

20. Method according to claim 18, wherein said fraction collection comprises collecting at least one fraction from an automated sampling system.

21. Method for introducing an analyte into a liquid chromatograph, wherein a set according to claim 12 is used to transfer the analyte onto a sorbent contained in a cartridge and wherein the cartridge is then accommodated in a line system through which a liquid stream is fed under high pressure to a liquid chromatograph.
